(19) United States
(12) Patent Application Publication
(10) Pub. No.: US 2016/0099800 A1
(43) Pub. Date: Apr. 7, 2016

(54) TRANSCEIVER AND OPERATION METHOD THEREOF

(71) Applicant: Chang-Joon PARK, Gyeonggi-do (KR)

(72) Inventor: Chang-Joon PARK, Gyeonggi-do (KR)

(21) Appl. No.: 14/721,547

(22) Filed: May 26, 2015

(30) Foreign Application Priority Data
Oct. 1, 2014 (KR) 10-2014-0132501

(51) Int. Cl. H04L 5/08; H04L 5/14; H04B 1/44; H04L 5/00

(52) U.S. Cl. CPC H04L 5/08; H04L 5/001; H04L 5/1461; H04B 1/44; H04W 88/06

(57) ABSTRACT

A receiver, a transceiver, and method of operating the transceiver are provided. The receiver includes a diplexer configured to separate a first band signal and a second band signal, the first band signal including a plurality of first subband signals; a first multi-mode switch configured to generate one or more signal paths corresponding to one or more of the plurality of first subband signals; and a plurality of first band pass filters configured to filter the plurality of first subband signals, wherein the plurality of first band pass filters and the first multi-mode switch are electrically coupled, and one or more of the plurality of first band pass filters, corresponding to one or more of the plurality of first subband signals, filter the plurality of first subband signals, respectively.

### PRIORITY

This application claims priority under 35 U.S.C. §119(a) to a Korean Patent Application filed on Oct. 1, 2014 in the Korean Intellectual Property Office and assigned Serial No. 10-2014-0132501, the entire content of which is incorporated herein by reference.

### BACKGROUND

1. Field of the Disclosure

The present disclosure relates generally to a transceiver and, more particularly, to a transceiver having a Front-End Module (FEM) structure for supporting Carrier Aggregation (CA).

2. Description of the Related Art

In general, mobile communication services are provided in different types of communication service schemes according to each nation (e.g. region), and a plurality of frequencies are used according to each communication service scheme. For example, mobile communication service schemes include various scheme such as a Personal Communication Service (PCS), a Digital Cellular System (DCS), a Code Division Multiple Access (CDMA) scheme, a Global System for Mobile communication (GSM)/General Packet Radio Service (GPRS) scheme, an Enhanced Data rates for GSM Evolution (EDGE) scheme, a Wideband Code Division Multiple Access (WCDMA) scheme, and a Long Term Evolution (LTE) scheme according to each nation (e.g. region). The CDMA scheme uses frequency bands of 800 MHz, 1800 MHz, and 1900 MHz. The GSM scheme uses frequency bands of 850 MHz, 900 MHz, 1800 MHz, and 1900 MHz. The WCDMA and LTE schemes use frequency bands of 850 MHz, 1900 MHz, and 2000 MHz.

Accordingly, users require mobile terminals that can receive all mobile communication services from all over the world. Further, terminal manufacturers attempt to manufacture terminals to enable a user to use all mobile communication services from all over the world through only one terminal based on users' demands. In order to use all mobile communication services from all over the world and all frequency bands for respective services, mobile terminals that support a Multi-Mode Multi-Band (MMMB) are required. “Multi-mode” refers to, for example, a Frequency Division Duplex (FDD) mode according to the WCDMA scheme and a Time Division Duplex (TDD) mode according to the GSM scheme, and “multi-band” refers to different frequency bands. For example, the MMMB that supports the FDD mode and the TDD mode, that is, two modes in the multi-mode, three service bands such as WCDMA 2000, WCDMA 1900, and WCDMA 850 in the FDD mode, and four service bands such as PCS 1900, DCS 1800, GSM 900, and GSM 850 in the TDD mode, may be supported by mobile terminals. In WCDMA 2000, WCDMA 1900, WCDMA 850, PCS 1900, DCS 1800, GSM 900, and GSM 850, 2000, 1900, 1800, and 850 have mean frequency bands of 2000 MHz, 1900 MHz, 1800 MHz, and 850 MHz, respectively.

Meanwhile, a Carrier Aggregation (CA) technology for supporting a high speed data transmission rate by a communication service provider's demand is applied to a communication system (for example, an LTE system). For example, a first communication service provider requires CA of a combination (for example, Band 3 and Band 5 (B3+B5)) of Mid Band (MB) and Low Band (LB) and a second communication service provider requires CA of a combination (for example, B3+B8) of MB and LB. A third communication service provider requires CA using three additional carriers.

A particular service provider requires CA using a combination of one High Band (HB) and two LBs or a combination of one MB and two LBs. For example, a transceiver including an FEM structure for supporting CA using a combination of B2+B5+B12, CA using a combination of B4+B5+B12, CA using a combination of B7+B8+B20, or CA using a combination of B2+B5+B 13 may be needed. B2 refers to a 1.9 GHz band, B5 refers to a 850 MHz band, B12 refers to a 800 MHz band, B4 refers to a 2.1 MHz band, B7 refers to a 2 GHz band, B8 refers to a 800 MHz band, and B13 refers to a 800 MHz band. The 800 MHz band may be included in the LB, and the 1.9 GHz to 2.1 GHz bands may be included in the HB or MB.

Accordingly, a transceiver including a Front-End Module (FEM) structure for supporting CA using three carriers may be required.

In order to support inter-band CA (e.g., B5+B12, B8+B20, or B5+B13) within the same band (for example, an LB), a quadplexer and a dual Surface Acoustic Wave (SAW) filter are required. The quadplexer and the dual SAW filter have a larger number of paths requiring matching between elements as compared to a duplexer and a SAW filter, and thus relatively further increase an Insertion Loss (IL). Accordingly, products specified for specific bands may be necessary for CA. Further, when the quadplexer and the dual SAW filter are applied to terminals, corresponding components should be used under a non-CA condition, because the IL may increase and, accordingly, performance deterioration occurs. Table 1 below shows the IL performance of the duplexer and the quadplexer.

TABLE 1

| Insertion Loss [dB] | B1 TX | B1 RX | B3 TX | B3 RX |
|---|---|---|---|---|
| Duplexer | 1.9 | 2.5 | 3.1 | 3.8 |
| Quadplexer | 2.3 | 2.7 | 4.2 | 4.0 |

As shown in Table 1 above, the IL of the quadplexer is larger than the IL of the duplexer.

### SUMMARY

The present disclosure has been made to address the above-mentioned problems and disadvantages, and to provide at least the advantages described below.

Accordingly, an aspect of the present disclosure provides a transceiver including a Front-End Module (FEM) structure for supporting CA using two or more carriers and an operation method thereof.

Another aspect of the present disclosure provides a transceiver including a structure which can support inter-band CA within the same band group and an operation method thereof.

Another aspect of the present disclosure provides a transceiver including a structure which can support inter-band CA to reduce performance deterioration due to an IL and an operation method thereof.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 illustrates a CA concept according to various embodiments of the present disclosure;

FIGS. 2A to 2C illustrate types of CA according to various embodiments of the present disclosure;

FIG. 3 is a block diagram of a transceiver according to an embodiment of the present disclosure;

FIGS. 4A and 4B are switches used for an FEM according to various embodiments of the present disclosure;

FIGS. 5A to 5D are block diagrams of an FEM within a transceiver of FIG. 3 according to various embodiments of the present disclosure;

FIGS. 6A and 6B are block diagrams of an FEM within the transceiver of FIG. 3 according to various embodiments of the present disclosure;

FIG. 7A to 7D are block diagrams of an FEM for a diversity within the transceiver of FIG. 3 according to various embodiments of the present disclosure; and

FIG. 8 is a flowchart illustrating a method of supporting CA by a transceiver according to an embodiment of the present disclosure.

### DETAILED DESCRIPTION OF EMBODIMENTS OF THE PRESENT DISCLOSURE

Hereinafter, various embodiments of the present disclosure are described in detail with reference to the accompanying drawings. Further, in the following description of the present disclosure, a detailed description of known functions and configurations incorporated herein are omitted when it may make the subject matter of the present disclosure rather unclear. The terms which are used below are terms defined in consideration of the functions in the present disclosure, and may be different according to users, intentions of the users, or customs. Therefore, the definitions of the terms should be determined based on the contents throughout the present disclosure.

In various embodiments of the present disclosure described below, a transceiver including a structure which can support inter-band Carrier Aggregation (CA) and an operation method thereof are described. Particularly, the present disclosure relates to a Front-End Module (FEM) electrically coupled between an Radio Frequency Integrated Circuit (RFIC) and an antenna in a terminal, and more particularly to a technology for supporting inter-band CA within the same band in a terminal having a signal path based on divided bands such as a High Band (HB), a Mid Band (MB), and a Low Band (LB).

Various embodiments of the present disclosure provide an additional signal path by using a dual mode (or direct mapping) switch instead of using a quadplexer and a dual Surface Acoustic Wave (SAW) for supporting an inter-band CA combination of the same band group in a terminal supporting CA.

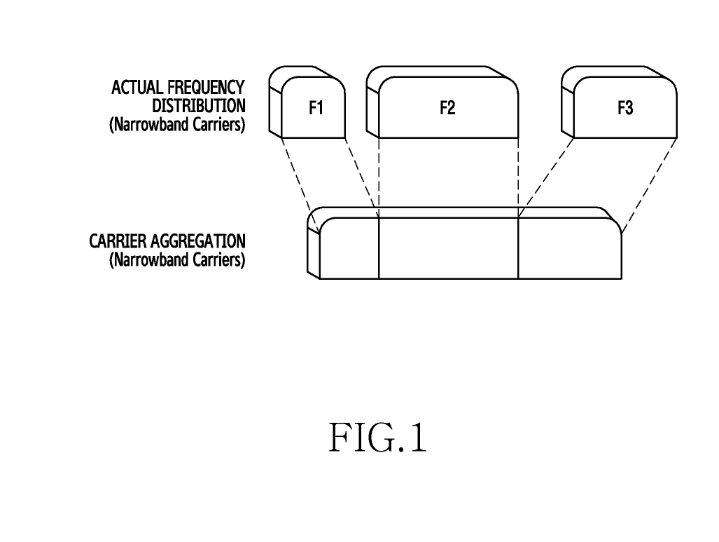

FIG. 1 illustrates a CA concept according to various embodiments of the present disclosure.

Referring to FIG. 1, according to various embodiments of the present disclosure, a CA technology combines narrowband carriers F1, F2, and F3 into one virtual broadband carrier. A bandwidth corresponding to F1, a bandwidth corresponding to F2, and a bandwidth corresponding to F3 may be located continuously or discontinuously. Further, the bandwidth corresponding to F1, the bandwidth corresponding to F2, and the bandwidth corresponding to F3 may have the same size or may have different sizes.

According to various embodiments of the present disclosure, the bandwidth corresponding to F1 may be an HB including a plurality of subbands, the bandwidth corresponding to F2 may be an MB including a plurality of subbands, and the bandwidth corresponding to F3 may be an LB including a plurality of subbands.

According to various embodiments of the present disclosure, the bandwidth corresponding to F1 may include some subbands of the MB including a plurality of subbands, the bandwidth corresponding to F2 may include some subbands of the LB including a plurality of subbands, and the bandwidth corresponding to F3 may include some subbands of the LB including a plurality of subbands.

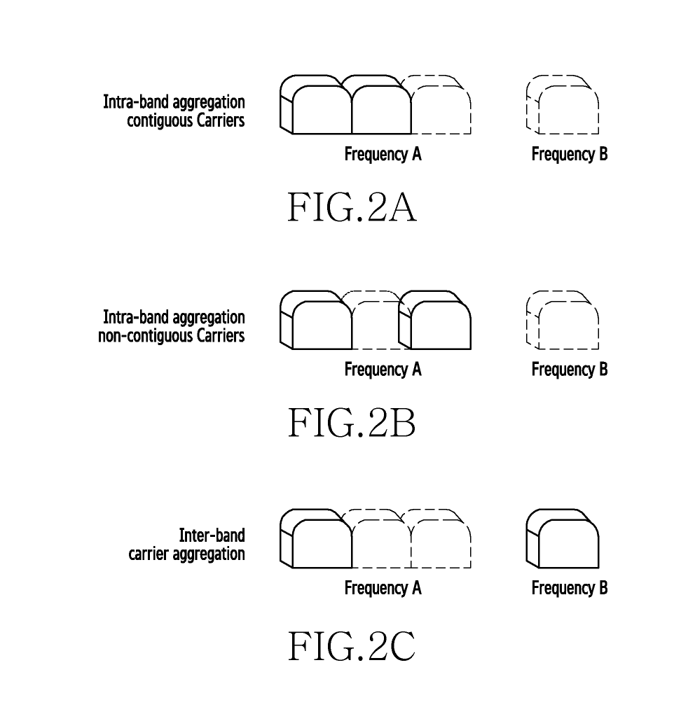

FIGS. 2A to 2C illustrate types of CA according to various embodiments of the present disclosure.

FIG. 2A illustrates intra-band contiguous carrier aggregation for connecting continuous carriers within the same band.

FIG. 2B illustrates intra-band non-contiguous carrier aggregation for connecting discontinuous carriers within the same band.

FIG. 2C illustrates inter-band carrier aggregation for connecting carriers within different bands. For example, the inter-band carrier aggregation may be inter-band carrier aggregation for connecting some subbands of the HB and some subbands of the MB, inter-band carrier aggregation for connecting some subbands of the MB and some subbands of the LB, or inter-band carrier aggregation for connecting a first subband and a second subband of the LB. The first subband and second subband of the LB may be discontinuous bands.

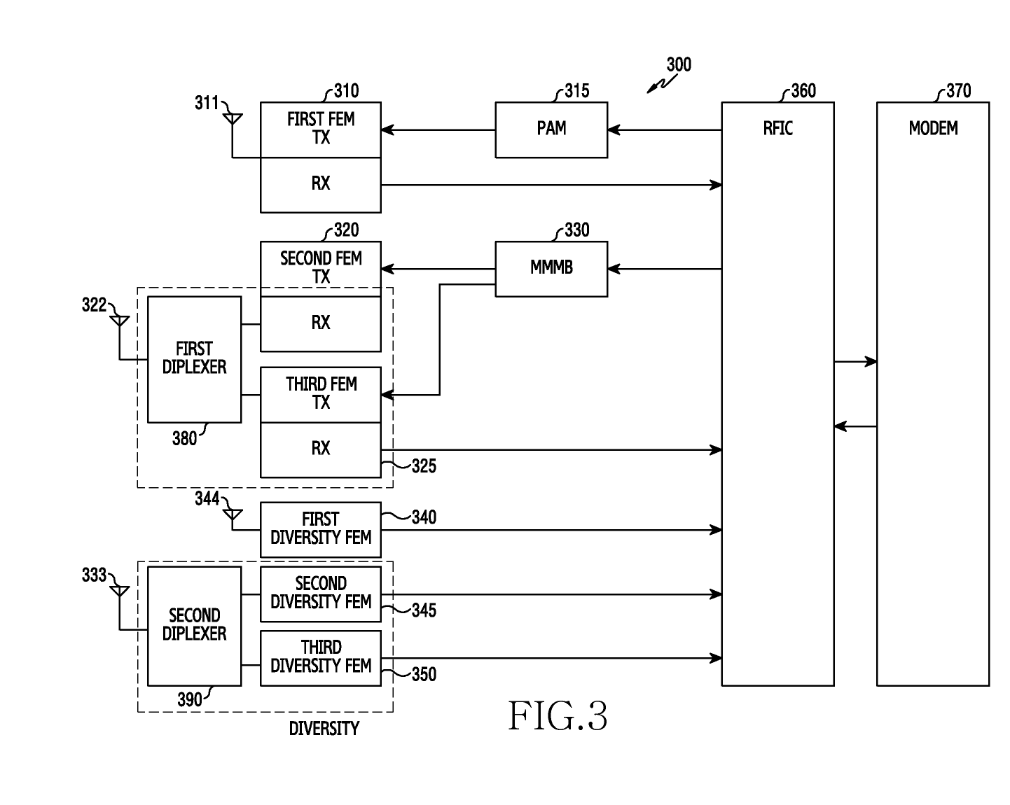

FIG. 3 is a block diagram of a transceiver according to various embodiments of the present disclosure.

Referring to FIG. 3, a transceiver 300 includes a first Front-End Module (FEM) 310 for filtering signals (hereinafter, referred to as subband signals of the HB) transmitted through subbands of the HB, a first diplexer 380 for separating band signals of the MB and the LB, a second FEM 320 for filtering subband signals of the separated MB, a third FEM 325 for filtering subband signals of the separated LB, a Power Amplifier Module (PAM) 315, a Multi-Mode Multi-Band (MMMB) 330, a Radio Frequency Integrated Circuit (RFIC) 360, and a Modulator/Demodulator (MODEM) 370. Further, the transceiver 300 may include a first diversity FEM 340 for filtering subband signals of the HB for diversity reception, a second diplexer 390 for separating band signals of the MB and the LB, a second diversity FEM 345 for filtering subband signals of the separated MB, and a third diversity FEM 350 for filtering subband signals of the separated LB.

The MODEM 370 modulates a transmission signal according to a control of a controller based on a preset modulation scheme, for example, a Quadrature Phase Shift Keying (QPSK) scheme, a 16 Quadrature Amplitude Modulation (16 QAM) scheme, and a 64 QAM scheme, and then outputs the modulated signal to the RFIC 360. Further, the MODEM 370 demodulates a signal received through an antenna based on a demodulation scheme corresponding to the modulation scheme, and then outputs the demodulated signal. Detailed descriptions of modulation and demodulation operations of the MODEM 370 are omitted herein.

The RFIC 360 converts a signal output from the MODEM 370 into an RF signal, and then outputs the converted RF signal to the PAM 315 or the MMMB 330. Alternatively, the RFIC 360 converts signal output from the first FEM 310, the second FEM 320, or the third FEM 325 into a baseband signal, and then outputs the converted signal to the MODEM 370. Detailed descriptions of operations for converting a signal into an RF signal or a baseband signal by the RFIC 360 are omitted.

The PAM 315 amplifies the RF signal from the RFIC 360 and outputs the amplified RF signal to the first FEM 310, and the MMMB 330 simultaneously amplifies the RF signal from the RFIC 360 of the MB and the LB and outputs the amplified RF signal corresponding to the MB to the second FEM 320 and the amplified RF signal corresponding to the LB to the third FEM 325.

The first FEM 310 filters RF signals of the subbands of the HB and then outputs the filtered RF signals through a first antenna (ANT) 311 or filters the signals of the subbands of the HB received by the first antenna 311 and then outputs the RF signals to the RFIC 360.

The second FEM 320 filters RF signals of the subbands of the MB and then outputs the filtered RF signals through a second antenna (ANT) 322 or filters the RF signals of the subbands of the MB received by the second antenna 322 and then outputs the signals to the RFIC 360.

The third FEM 325 filters RF signals of the subbands of the LB and then outputs the filtered RF signals through the second antenna (ANT) 322 or filters the RF signals of the subbands of the LB received through the second antenna 322 and then outputs the filtered RF signals to the RFIC 360.

According to various embodiments of the present disclosure, the first FEM 310, the second FEM 320, or the third FEM 325 may be implemented in various types and implemented in a form that includes at least one switch and a plurality of duplexers. Various implementation types of the first FEM 310, the second FEM 320, or the third FEM 325 are described below, so detailed descriptions thereof are omitted herein.

The first diplexer 380 separates band signals of the MB and the LB, and outputs an RF transmission signal through a second antenna 322 or to the RFIC 360. According to an embodiment of the present disclosure, the first diplexer 380 includes a Low Pass Filter (LPF) and a High Pass Filter (HPF).

In addition, in order to perform a diversity reception, the first diversity FEM 340 filters signals of the subbands of the HB received through the antenna 344 and then output the signals to the RFIC 360.

The second diversity FEM 345 filters signals of the subbands of the MB received through a third antenna 333 and then outputs the signals to the RFIC 360.

The third diversity FEM 350 filters signals of the subbands of the LB received through the third antenna 333 and then output the signals to the RFIC 360.

According to an embodiment of the present disclosure, the first diversity FEM 340, the second diversity FEM 345, or the third diversity FEM 350 may be implemented in various types and implemented in a form that includes at least one switch and a plurality of SAW filters. Various implementation types of the first diversity FEM 340, the second diversity FEM 345, or the third diversity FEM 350 are described below, so detailed descriptions thereof are omitted herein.

The second diplexer 390 separates band signals of the MB and the LB, and outputs an RF transmission signal through the third antenna 333 or receives an RF signal from the third antenna 333. According to an embodiment of the present disclosure, the second diplexer 390 includes a Low Pass Filter (LPF) and a High Pass Filter (HPF).

In addition, referring to a structure of the transceiver of FIG. 3, since a signal path using subbands of the HB, a signal path using subbands of the MB, and a signal path using subbands of the LB exist independently of each other, CA that uses the subbands of the HB, the MB, and the LB can be made.

According to an embodiment of the present disclosure, two or more signal paths for supporting inter-band CA within the same band (e.g., HB, MB, or LB) are required. Accordingly, in order to support CA by using two different subbands within the corresponding band, two signal paths are generated through a quadplexer and a dual SAW filter. For example, the quadplexer is included in the first FEM 310, the second FEM 320, or the third FEM 325, and the dual SAW filter is included in the first diversity FEM 340, the second diversity FEM 345, or the third diversity FEM 350.

According to an embodiment of the present disclosure, in order to support CA using two different subbands within the same band (e.g., HB, MB, or LB), two signal paths are generated through a dual mode (or direct mapping) switch. For example, the dual mode switch may be included in at least one of the first FEM 310, the second FEM 320, the third FEM 325, the first diversity FEM 340, the second diversity FEM 345, and the third diversity FEM 350 to support CA that uses subbands within the same band.

According to an embodiment of the present disclosure, in order to support CA using a plurality of different subbands within the same band (e.g., HB, MB, or LB), a plurality of signal paths are generated through a multi-mode switch. For example, the multi-mode switch may be included in at least one of the first FEM 310, the second FEM 320, the third FEM 325, the first diversity FEM 340, the second diversity FEM 345, and the third diversity FEM 350 to support CA that uses subbands within the same band.

Hereinafter, an example in which the dual mode switch is included in the third FEM 325 and the third diversity FEM 350 is described. However, the present disclosure is not limited to the case where the dual mode switch is included in the third FEM 325 and the third diversity FEM 350, but may be applied to cases where the dual mode switch is included in the second FEM 320 and the second diversity FEM 345 or the dual mode switch is included in the first FEM 310 and the first diversity FEM 340 in the same way.

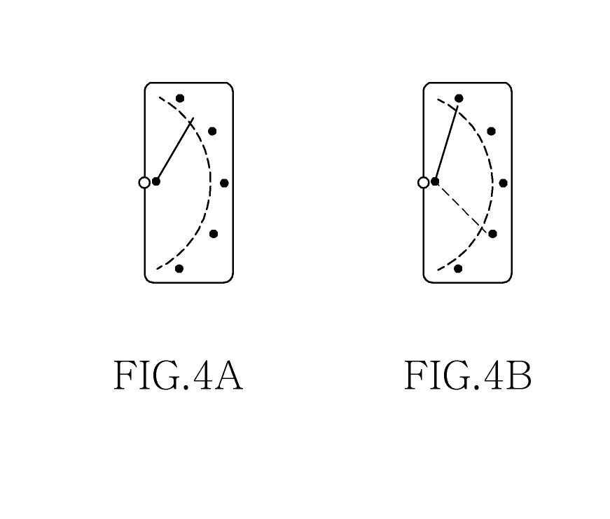

FIGS. 4A and 4B illustrate switches used for the FEM according to various embodiments of the present disclosure.

FIG. 4A illustrates a switch (for example, a Single-Pole n Throw (SPnT) switch) for generating one signal path, and FIG. 4B illustrates a dual mode switch for generating two signal paths. The dual mode switch may form two signal paths or one signal path according to a control signal.

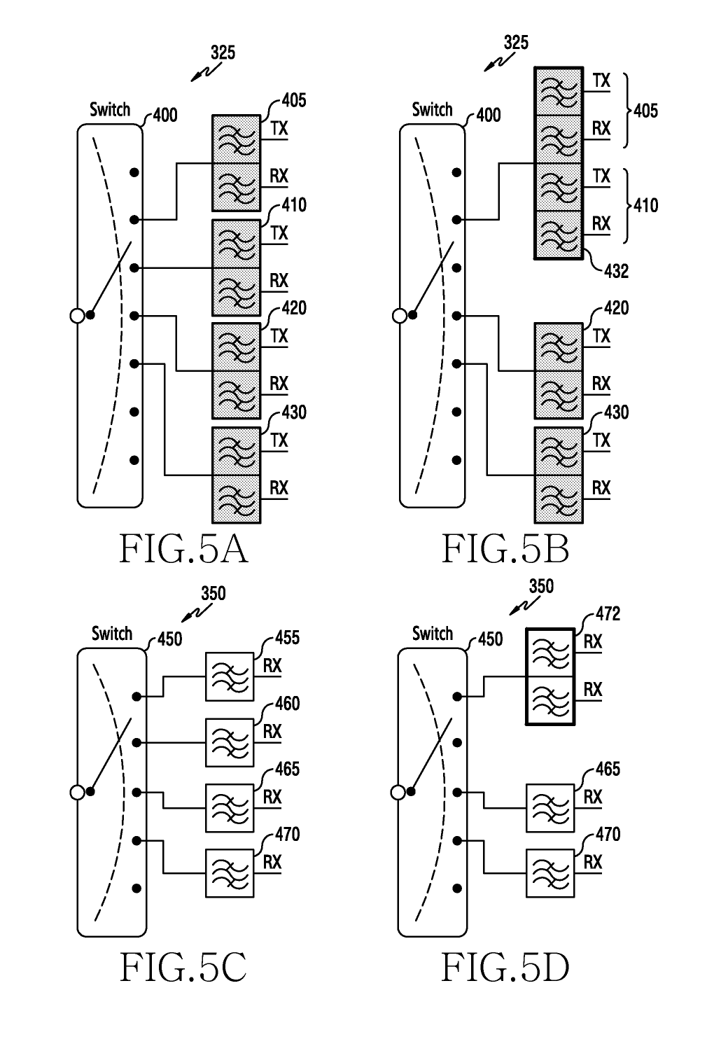

FIGS. 5A to 5D illustrate blocks of the third FEM 325 within the transceiver 300 of FIG. 3 according to various embodiments of the present disclosure.

Referring to FIG. 5A, the third FEM 325 includes a switch 400 for forming one signal path and four duplexers 405, 410, 420, and 430 for separating transmission and reception bands. For example, the switch 400 may switch to one of the four duplexers 405, 410, 420, and 430.

For example, the duplexer 405 separates transmission/reception RF signals of a communication scheme using a B5 band, the duplexer 410 separates the transmission/reception RF signals of a communication scheme using a B8 band, the duplexer 420 separates transmission/reception RF signals of a communication scheme using a B12 band, the duplexer 430 separates transmission/reception RF signals of a communication scheme using a B20 band. B5, B8, B 12, and B20 are subbands of the LB. When CA is used based on a combination of B5 and B8 bands, one quadplexer 432 for separating transmission/reception bands (that is, four frequency bands) for the B5 and B8 bands may be used instead of the duplexer 405 and the duplexer 410 as illustrated in FIG. 5B. The quadplexer 432 may be specified and operated for certain bands (e.g. B5 and B8). For example, the third FEM 325 may include the switch 400 for forming one signal path, one quadplexer 432, and two duplexers 420 and 430 for separating transmission/reception bands.

Referring to FIG. 5C, the third diversity FEM 350 includes a switch 450 for forming one signal path and four SAW filters 455, 460, 465, and 470. For example, the switch 450 switches to one of the four SAW filters 455, 460, 465, and 470. For example, the SAW filter 455 separates RF signals of a communication scheme using a B5 band, the SAW filter 460 separates RF signals of a communication scheme using a B8 band, the SAW filter 465 separates RF signals of a communication scheme using a B12 band, the SAW filter 470 separates RF signals of a communication scheme using a B20 band. B5, B8, B12, and B20 are subbands of the LB. When CA is used based on a combination of B5 and B8 bands, one dual SAW filter 472 for separating bands (that is, two frequency bands) for the B5 and B8 bands may be used instead of the SAW filter 455 and the SAW filter 460 as illustrated in FIG. 5D. The dual SAW filter 472 may be specified and operated for specific bands (B5 and B8). For example, the third diversity FEM 350 may include the switch 450 for forming one signal path, one dual SAW filter 472, and two SAW filters 465 and 470.

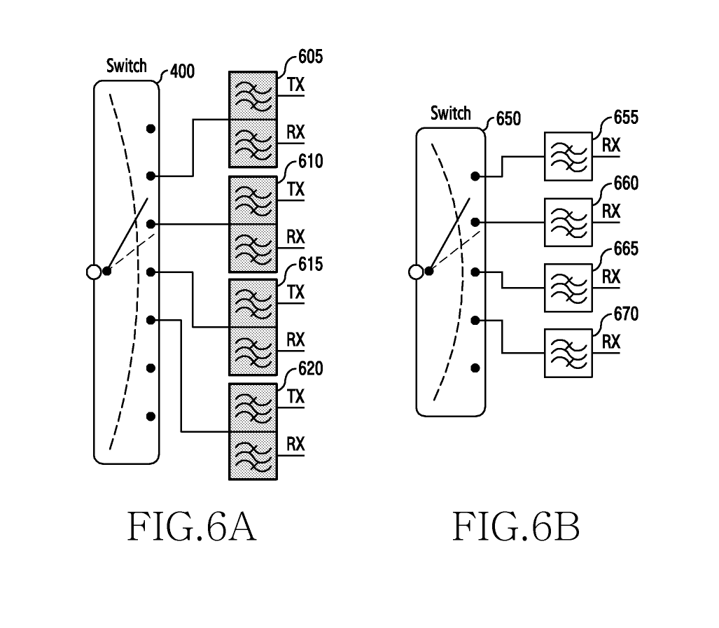

In addition, when the quadplexer and the dual SAW filter specified for specific bands are used as illustrated in FIGS. 5B and 5D, if inter-band CA is supported in the same LB, the number of paths requiring matching between elements is greater, so that an Insertion Loss (IL) may relatively increase. Accordingly, CA may be supported in the LB through the dual mode switches as illustrated in FIGS. 6A and 6B.

FIGS. 6A and 6B illustrate blocks of the third diversity FEM 350 within the transceiver 300 of FIG. 3 according to an embodiment of the present disclosure.

Referring to FIG. 6A, the third FEM 325 includes a dual mode switch 400 for forming two signal paths, and four duplexers 605, 610, 615, and 620 for separating transmission/reception bands. For example, the dual mode switch 400 switches to two of the four duplexers 605, 610, 615, and 620.

For example, the duplexer 605 separates transmission/reception RF signals of a communication scheme using a B5 band, the duplexer 610 separates transmission/reception RF signals of a communication scheme using a B8 band, the duplexer 615 separates transmission/reception RF signals of a communication scheme using a B 12 band, the duplexer 620 separates transmission/reception signals of a communication scheme using a B20 band. B5, B8, B12, and B20 are subbands of the LB. When CA is used based on a combination of B5 and B8 bands, the dual mode switch 400 simultaneously switches to the duplexer 605 and the duplexer 610. Alternatively, when CA is used based on a combination of B5 and B 12 bands, the dual mode switch 400 simultaneously switches to the duplexer 605 and the duplexer 615.

Referring to FIG. 6B, the third diversity FEM 350 includes a dual mode switch 650 for forming two signal paths and four SAW filters 655, 660, 665, and 670. For example, the dual mode switch 650 simultaneously switches to two of the four SAW filters 655, 660, 665, and 670.

For example, the SAW filter 655 separates RF signals of a communication scheme using a B5 band, the SAW filter 660 separates RF signals of a communication scheme using a B8 band, the SAW filter 665 separates RF signals of a communication scheme using a B12 band, the SAW filter 670 separates RF signals of a communication scheme using a B20 band. B5, B8, B12, and B20 are subbands of the LB. When CA is used based on a combination of B5 and B8 bands, the dual mode switch 650 simultaneously switches to the SAW filter 655 and the SAW filter 660. Alternatively, when CA is used based on a combination of B5 and B12 bands, the dual mode switch 650 simultaneously switches to the SAW filter 655 and the SAW filter 665.

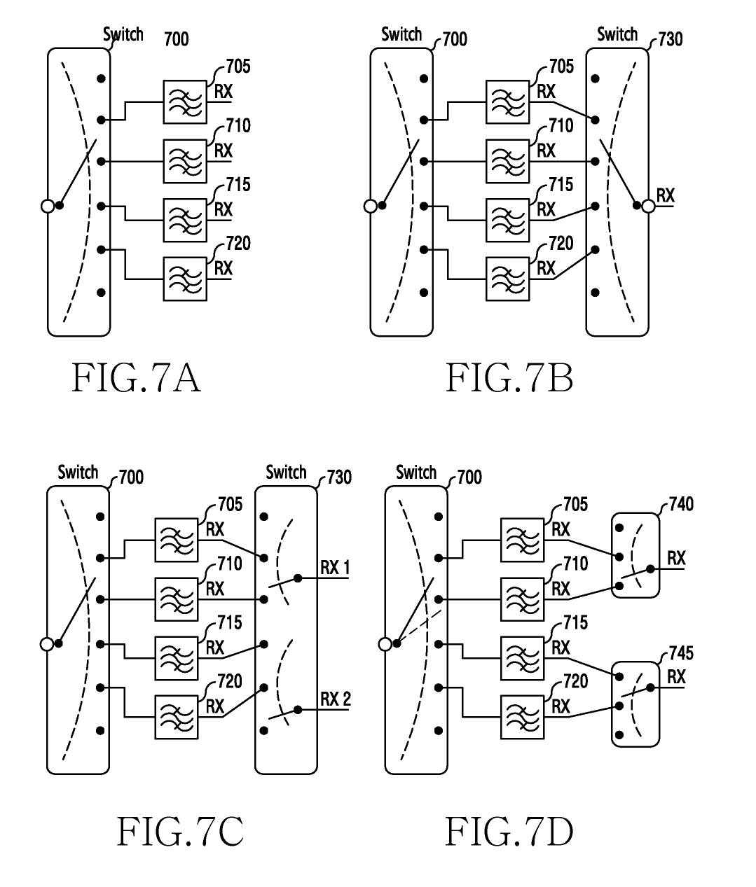

FIGS. 7A to 7D illustrate blocks of the third diversity FEM 350 within the transceiver 300 of FIG. 3 according to an embodiment of the present disclosure.

Referring to FIG. 7A, the third diversity FEM 350 that does not consider CA within the same band is illustrated, and the third diversity FEM 350 includes a switch 700 for forming one signal path and four SAW filters 705, 710, 715, and 720. The four SAW filters 705, 710, 715, and 720 are connected through ports of the RFIC 360, and thus have four signal paths.

When the four SAW filters 705, 710, 715, and 720 do not simultaneously output signals based on separated bands corresponding thereto and only one signal path is used, the remaining three signal paths are not used. As a result, due to the unnecessary signal paths, space for the signal paths is required within the transceiver.

In order to minimize space, an SPnT switch 730 is added to the outputs of the SAW filters 705, 710, 715, and 720 as illustrated in FIG. 7B, so that n signal paths can be reduced to only one signal path.

According to an embodiment of the present disclosure, in order to minimize space, a Dual-Pole n Throw (DPnT) switch 730 is added to the outputs of the SAW filters 705, 710, 715, and 720 as illustrated in FIG. 7C, so that n signal paths can be reduced to only one signal path.

According to an embodiment of the present disclosure, when CA is supported using subbands within the same band, signal paths can be reduced using a plurality of switches 740 and 745 in FIG. 7D by separating subbands which are not used at the same time.

For example, when four subbands of Band 5 (26), Band 8, Band 12 (17), and Band 20 within the LB are used, since Band 5 and Band 8 are not used with the same region at the same time, the ports may be shared through one switch 740. Also, since Band 12 and Band 20 are not used at the same time, ports may be shared through one switch 740. Since additional subbands of the LB such as Band 13, Band 28, and Band 29 may be used as well as Band 5, Band 8, Band 12, and Band 20, auxiliary ports may be used in light of the flexibility of respective RX ports.

Referring to FIG. 7C, the third diversity FEM 350 includes a switch 700 for forming two signal paths, four SAW filters 705, 710, 715, and 720, and two switches 740 and 745 for common use of RX ports in the light of the common use of the RX ports as well as CA support within the same band.

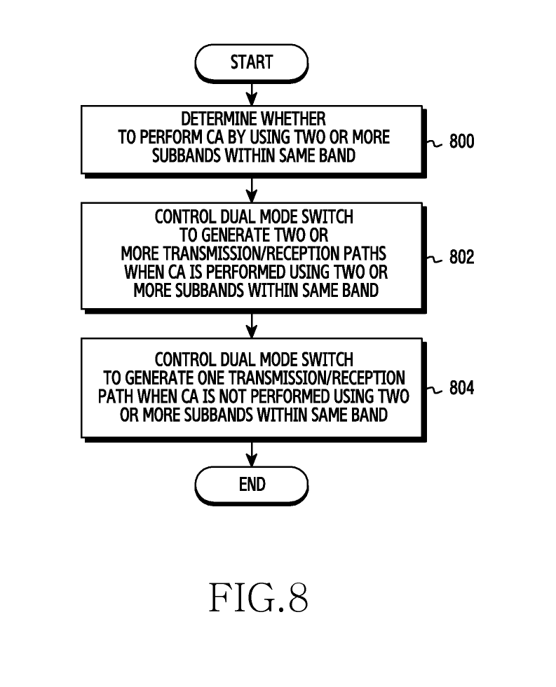

FIG. 8 is a flowchart of a method of supporting CA by a transceiver according to an embodiment of the present disclosure.

Referring to FIG. 8, a controller of the transceiver 300 determines whether to perform Carrier Aggregation (CA) by using two or more subbands within a first band, a second band, or a third band in step 800.

When the CA is performed using two or more subbands, the controller controls a dual mode switch to generate two or more transmission/reception paths in step 802.

When the CA is not performed using two or more subbands, the controller controls the dual mode switch to generate one transmission/reception signal path in step 804. The first band may be a Low Band (LB), the second band may be a Mid Band (MB), and the third band may be a High Band (HB).

In accordance with an aspect of the present disclosure, a method of operating a transceiver includes determining whether to perform Carrier Aggregation (CA) by using two or more subband signals within a first band, a second band, or a third band, controlling a dual mode switch to generate two or more transmission/reception paths when the CA is performed using the two or more subband signals and controlling the dual mode switch to generate one transmission/reception signal path when the CA is not performed using the two or more subband signals.

In accordance with an aspect of the present disclosure, the first band is a Low Band (LB), the second band is a Mid Band (MB), and the third band is a High Band (HB).

As described above, as the FEM uses the dual mode switch, it is not required to use a quadplexer and a dual Surface Acoustic Wave (SAW) filter which are specified for certain bands to support inter-band CA.

Further, the conventional duplexer and SAW filter can be reused and can support a random CA combination without any change in components.

In addition, under a non-CA condition, the dual mode switch operates as a switch for forming a single path, and thus can be used without performance deterioration.

While the present disclosure has been shown and described with reference to certain embodiments thereof, it will be understood by those skilled in the art that various changes in form and details may be made therein without departing from the scope and spirit of the present disclosure. Therefore, the scope of the present disclosure should not be defined as being limited to the embodiments, but should be defined by the appended claims and equivalents thereof.

What is claimed is:

1. A receiver, comprising:
a diplexer configured to separate a first band signal and a second band signal, the first band signal including a plurality of first subband signals;
a first multi-mode switch configured to generate one or more signal paths corresponding to one or more of the plurality of first subband signals; and
a plurality of first hand pass filters configured to fiber the plurality of first subband signals,
wherein the plurality of first band pass filters and the first multi-mode switch are electrically coupled, and one or more of the plurality of the first band pass filters, corresponding to one or more of the plurality of first subband signals, filter the plurality of first subband signals, respectively.

2. The receiver of claim 1, further comprising two or more first switches electrically coupled to the plurality of first hand pass filters, wherein the two or more first switches are configured to switch two or more signals, which do not simultaneously pass through the plurality of first band pass filters from among the plurality of first subband signals.

3. The receiver of claim 1, further comprising a second multi-mode switch configured to generate one or more signal paths corresponding to one or more second subband signals from among a plurality of second subband signals of the separated second band.

4. The receiver of claim 3, further comprising a plurality of second band pass filters configured to filter the plurality of second subband signals.

5. The receiver of claim 4, further comprising two or more second switches electrically coupled to the plurality of second band pass filters, wherein the two or more second switches are configured to switch two or more signals, which do not simultaneously pass through the plurality of second band pass filters from among the plurality of second subband signals.

6. The receiver of claim 4, wherein each of the plurality of first band pass filters or each of the plurality of second band pass filters is a Surface Acoustic Wave (SAW) filter.

7. The receiver of claim 1, wherein a first band is a Low Band (LB) and a second band is a Mid Band (MB), or the first band is the MB and the second band is the LB.

8. The receiver of claim 1, further comprising:
a third mode switch configured to generate one or more signal paths corresponding to one or more of a plurality of subband signals of a third band for performing Carrier Aggregation (CA) with at least one of a first band and a second band; and
a plurality of third band pass filters configured to filter the plurality of first subband signals.

9. The receiver of claim 8, further comprising two or more third switches electrically coupled to the plurality of third band pass filters, wherein the two or more third switches are configured to switch two or more signals, which do not simultaneously pass through the plurality of third band pass filters from among the plurality of third subband signals.

10. The receiver of claim 8, wherein the third band is a High Band (HB).

11. The receiver of claim 1, further comprising a controller configured to determine whether to perform Carrier Aggregation (CA) by using two or more subband signals in a first band, control a first dual mode switch to generate two or more signal paths when the CA is performed using the two or more subband signals, and control the first dual mode switch to generate one signal path when the CA is not performed using the two or more subband signals.

12. A transceiver, comprising:
a diplexer configured to separate a first band signal and a second band signal, the first band signal including a plurality of first subband signals;
a first multi-mode switch configured to generate one or more signal paths corresponding to one or more of the plurality of first subband signals; and
a plurality of first duplexers configured to filter the plurality of first subband signals, wherein the plurality of first duplexers and the first multi-mode switch are electrically coupled, and one or more of the plurality of first duplexers, corresponding to one or more of the plurality of first subband signals, filter the plurality of first subband signals, respectively.

13. The transceiver of claim 12, further comprising a second multi-mode switch configured to generate one or more signal paths corresponding to one or more second subband signals from among a plurality of second subband signals of the separated second band.

14. The transceiver of claim 13, further comprising a plurality of second duplexers configured to filter the plurality of second subband signals, wherein one of the plurality of first duplexers and the first multi-mode switch are electrically coupled, and one or more of the plurality of second duplexers, corresponding to one or more of the plurality of second subband signals, filter the plurality of second subband signals, respectively.

15. The transceiver of claim 12, wherein a first band is a Low Band (LB) and a second band is a Mid Band (MB), or the first band is the MB and the second band is the LB.

16. The transceiver of claim 12, further comprising:
a third multi-mode switch configured to generate one or more signal paths corresponding to one of a plurality of subband signals of a third band for performing Carrier Aggregation (CA) with at least one of a first band and a second band; and
a plurality of third duplexers configured to filter the plurality of first subband signals.

17. The transceiver of claim 16, wherein the third band is a High Band (HB).

18. The transceiver of claim 12, further comprising a controller configured to determine whether to perform Carrier Aggregation (CA) by using two or more subband signals in a first band, control a first dual mode switch to generate two or more transmission/reception paths when the CA is performed using the two or more subband signals, and control the first multi-mode switch to generate one transmission/reception signal path when the CA is not performed using the two or more subband signals.

19. A transceiver, comprising a chip set configured to:
determine whether to perform Carrier Aggregation (CA) by using two or more subband signals within a first band, a second band, or a third band;
control a dual mode switch to generate two or more transmission/reception paths when the CA is performed using the two or more subband signals; and
control the dual mode switch to generate one transmission/reception signal path when the CA is not performed using the two or more subband signals.

20. The transceiver of claim 19, wherein the first band is a Low Band (LB), the second band is a Mid Band (MB), and the third band is a High Band (HB).
